(19) United States
(12) Patent Application Publication
(10) Pub. No.: US 2011/0109268 A1
(43) Pub. Date: May 12, 2011

(54) BATTERY VOLTAGE BALANCE APPARATUS AND BATTERY CHARGE APPARATUS

(75) Inventors: Li-Min Lee, Taipei County (TW); Shian-Sung Shiu, Taipei County (TW); Chung-Che Yu, Taipei County (TW)

(73) Assignee: GREEN SOLUTION TECHNOLOGY CO., LTD., Taipei County (TW)

(21) Appl. No.: 12/891,789

(22) Filed: Sep. 27, 2010

(30) Foreign Application Priority Data
Nov. 12, 2009 (TW) 98138326

(51) Int. Cl. H02J 7/00

(52) U.S. Cl. 320/116

(57) ABSTRACT

A battery voltage balance apparatus including a balance determining unit and a converting unit is provided. The balance determining unit is coupled to a plurality of battery units and determines whether to perform a battery voltage balance process according to battery voltages of each battery units. The converting unit has an energy storage circuit and is coupled to the battery units. In the battery voltage balance process, the converting unit stores energy in the energy storage circuit and selectively charging at least one of the battery units by the energy storage circuit, so that the voltage differences between any two of the battery units are reduced to be lower than a predetermined value or a predetermined percentage.

### CROSS-REFERENCE TO RELATED APPLICATION

This application claims the priority benefit of Taiwan application serial no. 98138326, filed on Nov. 12, 2009. The entirety of the above-mentioned patent application is hereby incorporated by reference herein and made a part of this specification.

### BACKGROUND OF THE INVENTION

1. Field of the Invention

The invention generally relates to a battery voltage balance apparatus and a battery charge apparatus, and more particularly, to a battery voltage balance apparatus and a battery charge apparatus capable of balancing battery voltage by storing and converting electric power.

2. Description of Related Art

With the development of portable electronic products, the requirement for chargeable battery is gradually increased. The type of chargeable battery is classified into the conventional nickel-cadmium (NiCd) battery, the advanced nickel-metal hydride (NiMH) battery and lithium ion (Li-ion) battery, and the modern Li-Polymer battery. The voltage provided by the different type of chargeable battery is different, and the operation voltage of the portable electronic product is also different. Accordingly, the manufacturer may couple a plurality of batteries in series as a battery module to provide the desired voltage depending on the operation voltage of the portable electronic product.

When the energy of the batteries in the battery module has been depleted, a battery charger is needed to charge the battery module for next usage. However, the battery life may be different depending on manufacture and usage. For example, a 7.4V Li battery module is formed by two 3.7V Li batteries connected in series. Before the two batteries are dispatch from the factory, the remained energies of the batteries are respectively 80% and 70%. Because over charging will damage the Li battery, the Li battery charger may stop charging the Li battery when any of the batteries has been charged to full capacity. At this time, the stored energies of the two batteries may respectively be 100% (the maximum) and 90%. During usage, when any of the energy has fallen down to 0% (the minimum), the battery module can not be used. Accordingly, when the stored energies of the two batteries have respectively fallen down to 10% and 0%, the battery module must be charged before usage.

As known from above, when the stored energies of the batteries in the battery module are different, the available electric power of the battery module for usage is determined according to the battery having the lower battery life. Besides, when the battery is not used, the battery may self-discharge. In the condition that the self-discharge rate of each battery is different, the remained energy thereof will be gradually unbalanced, so that the available electric power of the battery module for usage also gradually decreases as the time goes on, thereby lowering the efficiency of the battery module and shortening the available usage time thereof.

Referring to FIG. 1, it shows a digital battery balance controller which is disclosed in the datasheet of ISL9208 by Intersil. A digital battery balance controller 10 includes a battery balance microcontroller 5 and transistor switches S1-S7. The transistor switches S1-S7 are respectively connected in parallel with the batteries BAT1-BAT7 through resistors R1-R7. The voltages of the batteries BAT1-BAT7 are converted to digital signals through A/D converters. According to the digital signals corresponding to the batteries BAT1-BAT7, the battery balance microcontroller 5 determines the battery having the highest voltage by a built-in algorithm, and further, turns on the transistor switch corresponding to the battery having the highest voltage. Accordingly, the charge current of each battery can be adjusted based on the voltage of each battery to achieve the function of battery voltage balance.

However, in order to perform the battery voltage balance by the battery balance microcontroller 5, the battery voltages must be converted to the digital signals through the A/D converters. The A/D converters will highly increase the chip area of the digital battery balance controller 10. Accordingly, the cost thereof is very high. Furthermore, the digital battery balance controller 10 adjusts the charge rate of each battery by shunting current through the resistors R1-R7. Shunting current through the resistors R1-R7 will generate unnecessary power consumption as well as heat. Particularly, in the charge condition using the large current or in a rapid-charge conduction, the lifespan of the battery will be shortened due to the high temperature condition.

### SUMMARY OF THE INVENTION

In the prior art, the cost of the digital battery balance controller is high, and by shunting current, the unnecessary power consumption as well as heat are generated. Accordingly, in an embodiment of the invention, an analog battery balance controller is used to achieve the function of battery voltage balance so as to reduce the cost of the battery balance controller. Furthermore, in an embodiment of the invention, by storing energy and converting electric power, the unnecessary power consumption is reduced for restraining temperature increase, and enhancing the converting efficiency of battery voltage balance as well as avoiding the issue which shortens the lifespan of the battery.

An embodiment of the invention provides a battery voltage balance apparatus including a balance determining unit and a converting unit. The balance determining unit is coupled to a plurality of battery units connected in series and determines whether to perform a battery voltage balance process according to battery voltages of each of the battery units. The converting unit has an energy storage circuit and is coupled to the battery units, and in the battery voltage balance process, the converting unit stores energy to the energy storage circuit and selectively charges at least one of the battery units by the energy storage circuit, so that voltage differences between any two of the battery units are reduced to be lower than a predetermined value or a predetermined percentage.

Another embodiment of the invention provides a battery charge apparatus used to charge a battery module. Herein, the battery module includes a plurality of battery units connected in series. The battery charge apparatus includes a charge control unit, a balance determining unit, and a converting unit. The charge control unit is coupled to a power source and the battery module, and the charge control unit controls the power source to provide a charge current to the battery module to charge the battery module. The balance determining unit is coupled to the battery module and determines whether to perform a battery voltage balance process according to battery voltages of each of the battery units. The converting unit has an energy storage circuit and is coupled to the battery units, and in the battery voltage balance process, the converting unit stores energy to the energy storage circuit and selectively charges at least one of the battery units by the energy storage circuit, so that voltage differences between any two of the battery units are reduced to be lower than a predetermined value or a predetermined percentage.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional digital battery balance controller.

FIG. 2 is a block diagram of a battery charge apparatus according to an embodiment of the invention.

FIG. 3 is a schematic circuit diagram of a battery voltage balance apparatus according to a first embodiment of the invention.

FIG. 4 is a schematic circuit diagram of a battery voltage balance apparatus according to a second embodiment of the invention.

FIG. 5 is a schematic circuit diagram of a battery voltage balance apparatus according to a third embodiment of the invention.

FIG. 6 is a schematic circuit diagram of a battery voltage balance apparatus according to a fourth embodiment of the invention.

FIG. 7 is a schematic circuit diagram of a battery voltage balance apparatus according to a fifth embodiment of the invention.

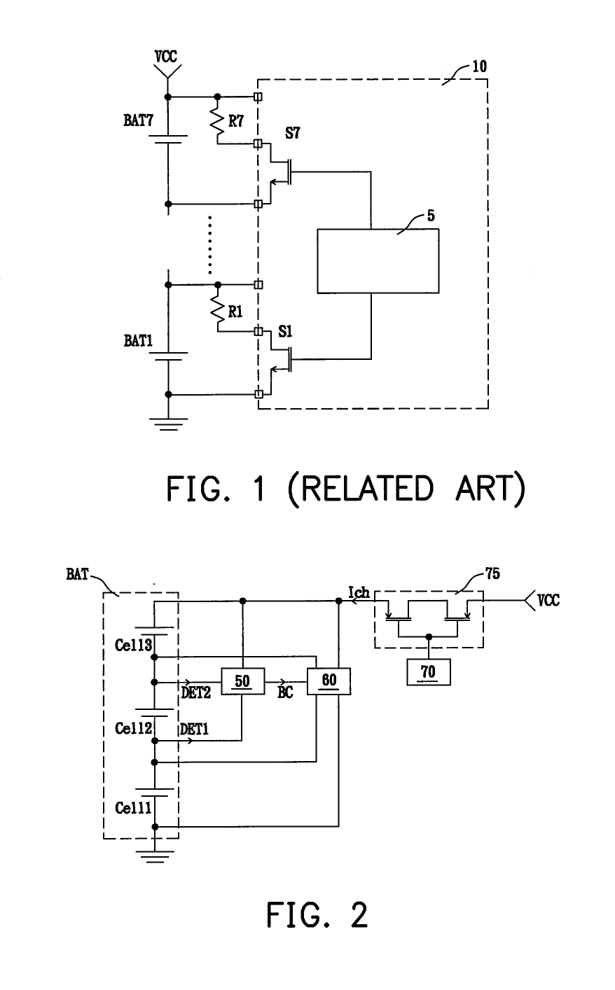

### DESCRIPTION OF EMBODIMENTS

FIG. 2 is a block diagram of a battery charge apparatus according to an embodiment of the invention. Referring to FIG. 2, the battery charge apparatus includes a charge control unit 70, a balance determining unit 50, and a converting unit 60. The battery charge apparatus is used to charge a battery module BAT. Herein, the battery module BAT includes a plurality of battery units Cell1, Cell2, and Cell3 connected in series, and the balance determining unit 50 and the converting unit 60 form a battery voltage balance apparatus. The charge control unit 70 determines whether to provide a charge current Ich from a power source VCC to charge the battery module BAT through a charge switch 75. The balance determining unit 50 is coupled to the battery module BAT, receives battery voltage detecting signals DET1 and DET 2 from the connections between the battery units Cell1, Cell2, and Cell3, and determines whether to perform a battery voltage balance process according to the battery voltages of each of the battery units. When the voltage differences between any two of the battery units Cell1, Cell2, and Cell3 are higher than a predetermined start percentage difference or a predetermined start voltage difference, the balance determining unit 50 generates a balance start signal BC to start the battery voltage balance process.

The converting unit 60 is coupled to the battery module BAT and has an energy storage circuit (not shown). The converting unit 60 performs the battery voltage balance process after receiving the balance start signal BC. In battery voltage balance process, the energy storage circuit stores energy and charges at least one of the battery units, thereby reducing the voltage differences between any two of the battery units to be lower than a second predetermined value or a second predetermined percentage. When charging the energy storage circuit, the charging electric power may get from the charge current Ich. For example, all of the charge current Ich or a part of the charge current Ich is conducted to the energy storage circuit for storing. Alternatively, a part of the electric power is provided by the charge current Ich, and the other part of the electric power is provided by the battery module BAT. In order to reduce the voltage differences between any two of the battery units Cell1, Cell2, and Cell3 to be lower than the predetermined end value or the predetermined end percentage, the electric power of the battery unit having the highest battery voltage or the charge current thereto can be stored in the energy storage circuit. Next, the electric power stored in the energy storage circuit is released to the battery unit having the lowest battery voltage or to the battery module BAT, i.e. all the battery units Cell1, Cell2, and Cell3. Alternatively, the electric power of all the battery units Cell1, Cell2, and Cell3 or the charge current can be stored in the energy storage circuit, and the electric power stored in the energy storage circuit is released to the battery unit having the lowest battery voltage later. Accordingly, the voltage differences between the battery unit having the highest battery voltage and the other battery units, or between the battery unit having the lowest battery voltage and the other battery units can be reduced. This will be discussed with reference to the following embodiment.

FIG. 3 is a schematic circuit diagram of a battery voltage balance apparatus according to a first embodiment of the invention. Referring to FIG. 3, the battery charge apparatus is coupled to a battery module having a plurality of battery units Cell1, Cell2, and Cell3 connected in series, and includes a balance determining unit 100 and a converting unit 120. The balance determining unit 100 includes a start circuit 105 and a voltage balance determining circuit 110. The start circuit 105 determines whether the voltage VDD is higher than a predetermined start voltage. Herein, the voltage VDD is provided by the plurality of battery units Cell1, Cell2, and Cell3 connected in series. If the voltage VDD is higher than the predetermined start voltage, the start circuit 105 generates a voltage determining start signal EN to ensure that the battery voltage balance apparatus can operate with a high enough driving voltage, thereby avoiding an erroneous operation due to the insufficient driving voltage. Furthermore, the start circuit 105 can also receive a start signal EA to start the battery voltage balance apparatus. That is, when the voltage VDD is higher than the predetermined start voltage, if the start signal EA is not received yet, the battery voltage balance apparatus is not operational. Accordingly, the battery voltage balance apparatus can operate with external circuit. For example, the start signal EA can be generated by the charge control unit 70 as shown in FIG. 2. When starting to charge the battery units Cell1, Cell2, and Cell3, the charge control unit 70 can generate the start signal EA. Accordingly, the battery voltage balance process is performed during the charge process instead of the non-charge process to avoid power loss in the battery units Cell1, Cell2, and Cell3. Alternatively, the charge control unit 70 can also generate the start signal EA to start the battery voltage balance process when all the battery units Cell1, Cell2, and Cell3 have been charged to a predetermined battery voltage level. Accordingly, for some batteries having memory effect, the charge control unit 70 can select a voltage range with rarely or no memory effect to perform the battery voltage balance process to avoid memory effect affecting the usage of batteries hereafter. When receiving the voltage determining start signal EN, the voltage balance determining unit 110 starts to detect the battery voltage of each battery unit according to the battery voltage detecting signals DET1 and DET 2 and the positive end and the negative end of the battery module having the battery units Cell1, Cell2, and Cell3 connected in series, which are respectively coupled to the voltage VDD and the ground. Accordingly, the voltage balance determining unit 110 determines whether to perform the battery voltage balance process. If so, the voltage balance determining unit 110 generates a balance start signal BC. For example, the voltage balance determining circuit 110 can generates the balance start signal BC when the voltage differences between any two of the battery units are higher than a predetermined start voltage difference or a predetermined start percentage difference, and the voltage balance determining circuit 110 stops generating the balance start signal BC when the voltage differences between any two of the battery units are reduced to a predetermined end value or a predetermined end percentage, or when the voltages of the battery units are equal.

The converting unit 120 has an energy storage circuit 140 and is coupled to the battery units Cell1, Cell2, and Cell3. When receiving the balance start signal BC, the converting unit 120 stores energy in the energy storage circuit 140 and selectively connects the energy storage circuit 140 in parallel with the battery units Cell1, Cell2, and Cell3 to charge one of them, so that the voltage differences between any two of the battery units Cell1, Cell2, and Cell3 are reduced to be lower than the predetermined end value or the predetermined end percentage. In the present embodiment, the converting unit 120 is a buck converting circuit to convert the voltage VDD to a predetermined charge voltage value. The predetermined charge voltage value can be determined according to the type of the battery unit and the voltage drop in the circuit. For example, if the battery unit is a Li-ion battery, the charge voltage is 4.2V, and the summation of the turn-on voltage of the transistor switch and the forward bias voltage of the diode of a switch module in the charge circuit is 0.9V, the predetermined charge voltage value is 5.1V (i.e. 4.2V+0.9V=5.1V).

The converting unit 120 includes the switch module, a control unit 125, and the energy storage circuit 140. Herein, the switch module includes an energy storage switch set 130 and an energy release switch set 135. The energy storage circuit stores the energy transmitted through the energy storage switch set 130 and releases the energy through the energy release switch set 135. The energy storage switch set 130 includes transistor switches M11 and M12 coupled to the positive end and the negative end of the battery module, which are respectively coupled to the voltage VDD and the ground. The energy release switch set 135 includes transistor switches M13, M14, M15, M16 and M17 and a diode D18. The energy storage circuit 140 includes an inductor L1 and a capacitor C1, and is coupled between the energy storage switch set 130 and the energy release switch set 135.

When receiving the balance start signal BC, the control unit 125 starts to generate control signals S11-S17 corresponding to the transistor switches M11-M17 to perform the energy storage and the energy release of the energy storage circuit 140. During a first timing, the control unit 125 turns on the transistor switches M11 and M17 to couple the energy storage circuit 140 to the positive end of the battery module, so that the voltage VDD provides energy to store in the energy storage circuit 140. During a second timing, the control unit 125 turns on the transistor switch M12 and cuts off the transistor switch M11, so that the current of the inductor L1 flows through the capacitor C1 and the transistor switch M12. The length of the first timing T1 and the length of the second timing T2 can be determined according to the predetermined charge voltage value and the voltage VDD. That is, Duty Cycle=the predetermined charge voltage value/the voltage VDD=T1/(T1+T2). In order to ensure that the current of the inductor is not too high, the length of the first timing T1 can be set as a predetermined length or set to be shorter than the predetermined length, so that the current of the inductor L1 can be ensured being lower than a limit current value.

The transistor switches in the energy release switch set 135 are turned on or cut off according to which one of the battery units Cell1, Cell2, and Cell3 has the lowest battery voltage. If the battery unit Cell1 has the lowest battery voltage, during the second timing, the transistor switches M15 and M17 in the energy release switch set 135 are turned on, and the other transistor switches in the energy release switch set 135 are cut off, so that the capacitor C1 in the energy storage circuit 140 is connected in parallel with the battery unit Cell1 through the transistor switches M15 and M17 to charge it. If the battery unit Cell2 has the lowest battery voltage, during the second timing, the transistor switches M13 and M16 in the energy release switch set 135 are turned on, and the other transistor switches in the energy release switch set 135 are cut off. Accordingly, during the second timing, by the turn-on of the transistor switches M13 and M16, the capacitor C1 is connected in parallel with the battery unit Cell2 to charge it. If the battery unit Cell3 has the lowest battery voltage, during the second timing, the transistor switch M14 in the energy release switch set 135 is turned on, and the other transistor switches in the energy release switch set 135 are cut off.

Accordingly, during the second timing, by the turn-on of the transistor switch M14, the capacitor C1 and the diode D18 are connected with the battery unit Cell3 in parallel to charge it.

Furthermore, in order to avoid the capacitor C1 being released energy through the body diodes of the transistor switches M13, M15, and M16, the substrates thereof are all grounded, so that the body diodes can not be forward biased to affect the operation of the circuit.

As described above, during the battery voltage balance process, the converting unit 120 selectively connects the energy storage circuit 140 in parallel with one of the battery units Cell1, Cell2, and Cell3 having the lowest battery voltage according to the balance start signal BC, so that the battery unit having the lowest battery voltage is charged until the battery voltage balance process terminates. Furthermore, by storing and converting the electric power the converting unit 120 can make most of the electric power be used in the battery voltage balance process instead of be consumed. Compared with the prior art, the efficiency of the circuit in the invention is higher, and the heat can also be reduced during the battery voltage balance process.

Besides the above buck converting circuit, the converting unit of the invention can be any converting unit capable of storing and converting energy. Accordingly, the converting unit of the invention can store and convert energy and charge at least one of the battery units, so that the charge rates of the battery unit having the highest battery voltage and the battery unit having the lowest battery voltage are different, and the voltage difference thereof is gradually reduced.

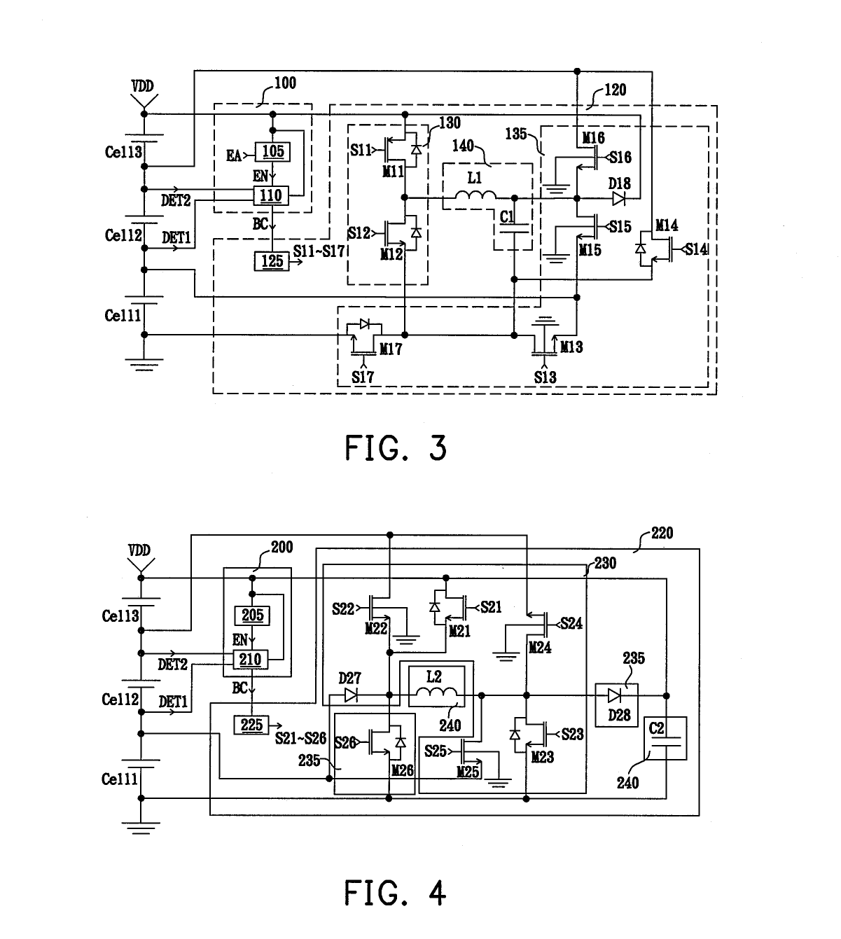

FIG. 4 is a schematic circuit diagram of a battery voltage balance apparatus according to a second embodiment of the invention. Referring to FIG. 4, in the present embodiment, the converting unit 220 is a boost converting circuit. The battery voltage balance apparatus is coupled to a plurality of battery units Cell1, Cell2, and Cell3 connected in series, and includes a balance determining unit 200 and a converting unit 220. The balance determining unit 200 includes a start circuit 205 and a voltage balance determining circuit 210. Herein, the start circuit 205 is used to determine whether the voltage VDD is higher than a predetermined start voltage to generate a voltage determining start signal EN to start the battery voltage balance apparatus. When receiving the voltage determining start signal EN, the voltage balance determining unit 210 starts to detect the battery voltages of each battery units according to the battery voltage detecting signals DET1 and DET 2 and the positive end and the negative end of the battery module, which are respectively coupled to the voltage VDD and the ground. The difference between the present embodiment and that of FIG. 2 is that the start circuit 105 does not receive a start signal EA from external circuit. Instead, the voltage balance determining unit 210 is used to determine whether any one of the battery voltages of the battery units Cell1, Cell2, and Cell3 are higher than the predetermined battery voltage level. If so, and the voltage differences between any two of the battery units are higher than a predetermined start voltage difference or a predetermined start percentage difference, the voltage balance determining circuit 210 generates the balance start signal BC to inform the converting unit 220 which one of the battery units has the highest battery voltage, so that the converting unit 220 performs the battery voltage balance process.

The converting unit 220 includes a control unit 225, a switch module, and an energy storage circuit 240. Herein, the switch module includes an energy storage switch set 230 and an energy release switch set 235. The energy storage switch set 230 includes transistor switches M21, M22, M23, M24, and M25 and a diode D27 which are respectively coupled to the positive ends and the negative ends of the battery units Cell1, Cell2, and Cell3. The energy release switch set 235 includes transistor switches M26 and a diode D28 which is coupled to the positive end of the battery module, i.e. the voltage VDD. The energy storage circuit 240 includes an inductor L2 and a capacitor C2, and is coupled between the energy storage switch set 230 and the energy release switch set 235. The converting unit 220 stores the electric power of one of the battery units Cell1, Cell2, and Cell3 having the highest battery voltage (during the charge process, it may be a part of charge current for charging the battery module or the combination of the charge current and the electric power of the battery units) in the energy storage circuit 240 and boosts it to provide the electric power for all of the battery units Cell1, Cell2, and Cell3 and charge them. An operation of the circuit is provided henceforth.

When receiving the balance start signal BC, the control unit 225 starts to generate control signals S21-S26 corresponding to the transistor switches M21-M26 to perform the energy storage and the energy release of the energy storage circuit 240. If the battery unit Cell1 has the highest battery voltage, during the first timing, the transistor switch M23 in the energy storage switch set 230 is turned on, and the other transistor switches are cut off, so that the inductor L2 in the energy storage circuit 240 stores energy through the transistor switch M23 and the diode D27. Furthermore, during the second timing, all the transistor switches in the energy storage switch set 230 are cut off, and the transistor switch M26 in the energy release switch set 235 is turned on, so that the current of the inductor L2 flows through the transistor switch M26 and the diode D28. If the battery unit Cell2 has the highest battery voltage, during the first timing, the transistor switches M22 and M25 in the energy storage switch set 230 are turned on, and the other transistor switches are cut off, so that the inductor L2 in the energy storage circuit 240 stores energy through the transistor switches M22 and M25. Furthermore, during the second timing, all the transistor switches in the energy storage switch set 230 are cut off, and the transistor switch M26 in the energy release switch set 235 is turned on, so that the current of the inductor L2 flows through the transistor switch M26 and the diode D28. If the battery unit Cell3 has the highest battery voltage, during the first timing, the transistor switches M21 and M24 in the energy storage switch set 230 are turned on, and the other transistor switches are cut off, so that the inductor L2 in the energy storage circuit 240 stores energy through the transistor switches M21 and M24. Furthermore, during the second timing, all the transistor switches in the energy storage switch set 230 are cut off, and the transistor switch M26 in the energy release switch set 235 is turned on, so that the current of the inductor L2 flows through the transistor switch M26 and the diode D28.

The voltage drop across the capacitor C2 in the energy storage circuit 240 of the converting unit 220 is raised to a predetermined charge voltage value to charge the battery units Cell1, Cell2, and Cell3. In the present embodiment, the predetermined charge voltage value can be determined according to the type of the battery unit. For example, if the battery unit is a Li-ion battery, and the charge voltage thereof is 4.2V, the predetermined charge voltage value is 12.6V (i.e. 4.2V*3=12.6V). Furthermore, the duty cycle can be determined according to the step-up ratio of the boost circuit. That is, according to the predetermined charge voltage value/the highest one of the battery voltages, the length ratio of the first timing and the second timing can be determined. In addition, the length of the first timing T1 can be limited to be equal to or shorter than a predetermined length, so that the current of the inductor L2 can be ensured being lower than a limit current value.

Moreover, in order to avoid the capacitor C2 being released energy through the body diodes of the transistor switches M22, M24, and M25, the substrates thereof are all grounded, so that the body diodes can not be forward biased to affect the operation of the circuit.

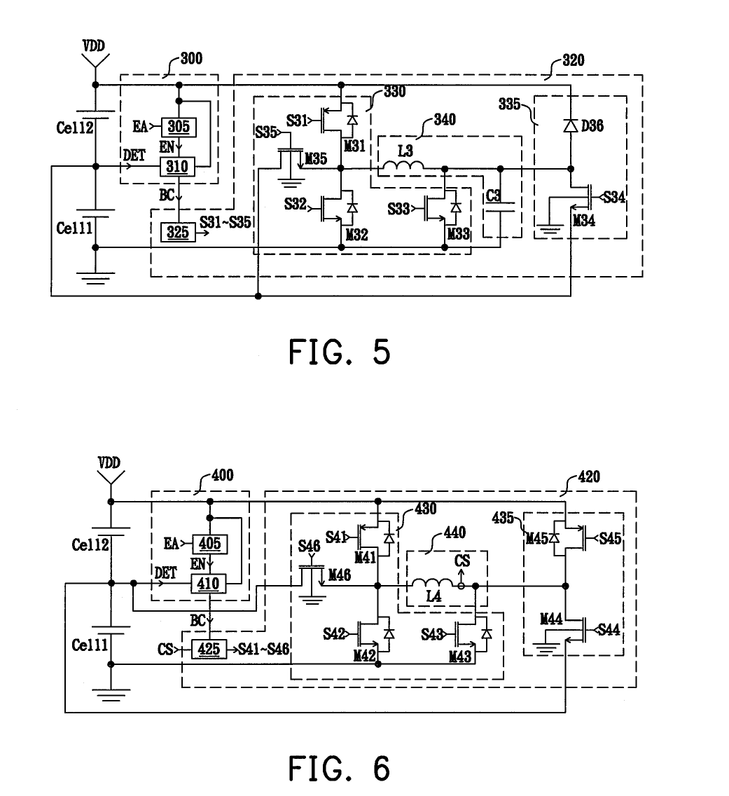

FIG. 5 is a schematic circuit diagram of a battery voltage balance apparatus according to a third embodiment of the invention. Referring to FIG. 5, the battery voltage balance apparatus includes a balance determining unit 300 and a converting unit 320 and is coupled to a plurality of battery units Cell1 and Cell2 connected in series. In the present embodiment and the following embodiment, in order to explain briefly, the battery module having the battery units Cell1 and Cell2 are taken as an example.

The balance determining unit 300 includes a start circuit 305 and a voltage balance determining circuit 310. Herein, after receiving the start signal EA, the start circuit 305 starts to determine whether the voltage VDD is higher than a predetermined start voltage. If so, the start circuit 305 generates a voltage determining start signal EN to start the battery voltage balance apparatus. When receiving the voltage determining start signal EN, the voltage balance determining unit 310 starts to detect the battery voltage of each battery unit according to the battery voltage detecting signal DET (i.e. the voltage of the connection of the positive end of the battery unit Cell1 and the negative end of the battery unit Cell2) and the positive end and the negative end of the battery module, which are respectively coupled to the voltage VDD and the ground. If the voltage difference between the two battery units is higher than a predetermined start voltage difference or a predetermined start percentage difference, the voltage balance determining circuit 310 generates the balance start signal BC to inform the converting unit 320 which one of the battery units has the highest battery voltage or the lowest battery voltage to start the battery voltage balance process. In the present embodiment, the converting unit 320 is a buck/boost converting circuit which can perform the battery voltage balance process in the boost method or in the buck method according to the status between the battery units Cell1 and Cell2.

The converting unit 320 includes a control unit 325, a switch module, and an energy storage circuit 340. Herein, the switch module includes an energy storage switch set 330 and an energy release switch set 335. The control unit 325 generates control signals S31-S35 corresponding to the transistor switches M31-M35 to perform the energy storage and the energy release of the energy storage circuit 340. The energy storage switch set 330 includes the transistor switches M31, M32, M33, and M35. The energy release switch set 335 includes the transistor switch M34 and a diode D36. The energy storage circuit 340 includes an inductor L3 and a capacitor C3, and is coupled between the energy storage switch set 330 and the energy release switch set 335.

When the voltage of the battery unit Cell1 is smaller than that of the battery unit Cell2, the converting unit 320 performs the battery voltage balance process in the buck method. At this time, during a first timing, the transistor switch M31 is turned on, and the transistor switches M32, M33, and M35 are cut off, so that the energy storage circuit 340 stores energy. During a second timing, the transistor switches M31, M33, and M35 are cut off, and the transistor switches M32 and M34 are turned on, so that the current of the inductor L3 flows through the transistor switches M32 and M34. The voltage drop across the capacitor C3 in the energy storage circuit 340 is stabilized at a predetermined charge voltage value to charge the battery unit Cell1 through the turned-on transistor switch M34. In the present embodiment, the predetermined charge voltage value is the charge voltage added with the turn-on voltage of the transistor switch M34.

When the voltage of the battery unit Cell1 is larger than that of the battery unit Cell2, the converting unit 320 performs the battery voltage balance process in the boost method. At this time, during the first timing, the transistor switches M33 and M35 are turned on, and the transistor switches M31, M32, and M34 are cut off, so that the inductor L3 in the energy storage circuit 340 stores energy. During the second timing, the transistor switches M31, M32, M33, and M34 are cut off, and the transistor switch M35 is still turned on, so that the current of the inductor L3 flows through the transistor switch M35. The voltage drop across the capacitor C3 in the energy storage circuit 340 is stabilized at the predetermined charge voltage value to charge the battery units Cell1 and Cell2 through the diode D36. In the present embodiment, the predetermined charge voltage value is the charge voltage of the two battery units added with the forward bias voltage of the diode D36.

Furthermore, in order to avoid the capacitor C3 being released energy through the body diodes of the transistor switches M34 and M35, the substrates thereof are all grounded, so that the body diodes can not be forward biased to affect the operation of the circuit.

FIG. 6 is a schematic circuit diagram of a battery voltage balance apparatus according to a fourth embodiment of the invention. Referring to FIG. 6, the battery voltage balance apparatus includes a balance determining unit 400 and a converting unit 420 and is coupled to a plurality of battery units Cell1 and Cell2 connected in series. The balance determining unit 400 includes a start circuit 405 and a voltage balance determining circuit 410. Herein, after receiving the start signal EA, the start circuit 405 starts to generate a voltage determining start signal EN according to the voltage VDD to start the battery voltage balance apparatus. When receiving the voltage determining start signal EN, the voltage balance determining unit 410 starts to detect the battery voltage of each battery unit according to the battery voltage detecting signal DET and the positive end and the negative end of the battery module, which are respectively coupled to the voltage VDD and the ground. If the voltage difference between the two battery units is higher than a predetermined start voltage difference or a predetermined start percentage difference, the voltage balance determining circuit 410 generates the balance start signal BC to inform the converting unit 420 which one of the battery units has the highest battery voltage or the lowest battery voltage to start the battery voltage balance process.

The converting unit 420 includes a control unit 425, a switch module, and an energy storage circuit 440. Herein, the switch module includes an energy storage switch set 430 and an energy release switch set 435. The energy storage switch set 430 includes the transistor switches M41, M42, M43, and M46. The energy release switch set 435 includes the transistor switches M44 and M45. In the present embodiment, the energy storage circuit 440 simply includes an inductor L4 and is coupled between the energy storage switch set 430 and the energy release switch set 435. When receiving a current detecting signal CS indicative of a current flowing through the inductor L4, the control unit 425 starts to generate control signals S41-S46 corresponding to the transistor switches M41-M46 to perform the energy storage and the energy release of the energy storage circuit 440.

The control unit 425 can control the energy storage switch set 430 to store the electric power by the voltage of the battery module (during the charge process, it may be a part of charge current or the combination of the charge current and the electric power of the battery units) to the inductor L4. Furthermore, the energy storage switch set 430 charges one of the battery units Cell1 and Cell2 having the lowest battery voltage to balance the battery voltages of the battery units Cell1 and Cell2. Detailed descriptions are given as follows.

When the voltage of the battery unit Cell1 is smaller than that of the battery unit Cell2, during the first timing, the control unit 425 generates the control signals S41 and S43 to turn on the transistor switches M41 and M43 and cut off the other transistor switches, so that the inductor L4 stores energy. Next, during the second timing, the control unit 425 generates the control signals S42 and S44 to turn on the transistor switches M42 and M44 and cut off the other transistor switches, so that the inductor L4 releases the stored electric power to charge the battery unit Cell1 through the transistor switches M42 and M44. When the voltage of the battery unit Cell1 is larger than that of the battery unit Cell2, during the first timing, the control unit 425 generates the control signals S41 and S43 to turn on the transistor switches M41 and M43 and cut off the other transistor switches, so that the inductor L4 stores energy. Next, during the second timing, the control unit 425 generates the control signals S45 and S46 to turn on the transistor switches M45 and M46 and cut off the other transistor switches, so that the inductor L4 releases the stored electric power to charge the battery unit Cell2 through the transistor switches M45 and M46.

Certainly, the control unit 425 can also control the energy storage switch set 430 to store the electric power of one of the battery units Cell1 and Cell2 having the highest battery voltage (during the charge process, it may be a part of charge current or the combination of the charge current and the electric power of the battery units) to the inductor L4. Furthermore, the energy storage switch set 430 charges one of the battery units Cell1 and Cell2 having the lowest battery voltage to balance the battery voltages of the battery units Cell1 and Cell2. Detailed descriptions are given as follows.

When the voltage of the battery unit Cell1 is smaller than that of the battery unit Cell2, during the first timing, the control unit 425 generates the control signals S41 and S44 to turn on the transistor switches M41 and M44 and cut off the other transistor switches, so that the battery unit Cell2 charges the inductor L4, and thus, the inductor L4 stores energy. Next, during the second timing, the control unit 425 generates the control signals S42 and S44 to turn on the transistor switches M42 and M44 and cut off the other transistor switches, so that the inductor L4 releases the stored electric power to charge the battery unit Cell1 through the transistor switches M42 and M44. When the voltage of the battery unit Cell1 is larger than that of the battery unit Cell2, during the first timing, the control unit 425 generates the control signals S43 and S46 to turn on the transistor switches M43 and M46 and cut off the other transistor switches, so that the battery unit Cell1 charges the inductor L4, and thus, the inductor L4 stores energy. Next, during the second timing, the control unit 425 generates the control signals S45 and S46 to turn on the transistor switches M45 and M46 and cut off the other transistor switches, so that the inductor L4 releases the stored electric power to charge the battery unit Cell2 through the transistor switches M45 and M46.

In the present embodiment, the control unit 425 controls the size of the current flowing through the inductor L4 by the current detecting signal CS. Accordingly, the current of the inductor L4 is limited to be lower than a limit current value to avoid a huge current being generated to affect or damage the battery unit. Furthermore, the control unit 425 can also stabilize the current of the inductor L4 near a limit current value. At this time, the inductor L4 stays in a continuous current mode, so that the transmission rate of the electric power is faster, thereby reducing the time for balancing the battery voltage.

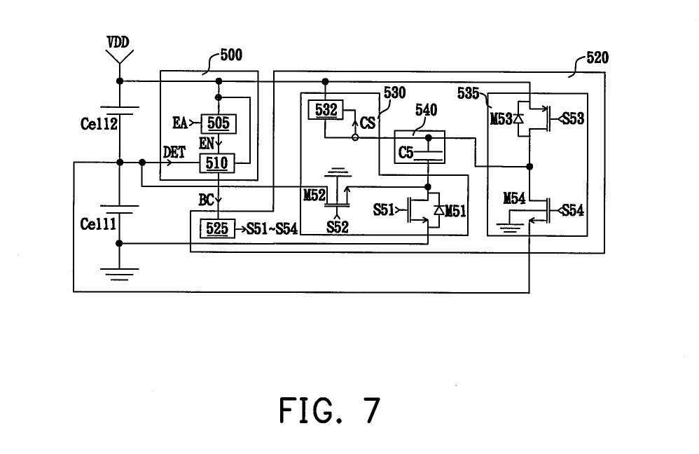

FIG. 7 is a schematic circuit diagram of a battery voltage balance apparatus according to a fifth embodiment of the invention. Referring to FIG. 7, the battery voltage balance apparatus includes a balance determining unit 500 and a converting unit 520 and is coupled to a plurality of battery units Cell1 and Cell2 connected in series. The balance determining unit 500 includes a start circuit 505 and a voltage balance determining circuit 510. Herein, after receiving the start signal EA, the start circuit 505 starts to generate a voltage determining start signal EN according to the voltage VDD to start the battery voltage balance apparatus. When receiving the voltage determining start signal EN, the voltage balance determining unit 510 starts to detect the battery voltage of each battery unit according to the battery voltage detecting signal DET and the positive end and the negative end of the battery module. If the voltage difference between the two battery units is higher than a predetermined start voltage difference or a predetermined start percentage difference, the voltage balance determining circuit 510 generates the balance start signal BC to inform the control unit 520 which one of the battery units has the highest battery voltage or the lowest battery voltage to start the battery voltage balance process.

The control unit 520 includes a control unit 525, a switch module, and an energy storage circuit 540. Herein, the switch module includes an energy storage switch set 530 and an energy release switch set 535. The energy storage switch set 530 includes the transistor switches M51 and M52 and a linear regulator 532. The energy release switch set 535 includes the transistor switches M53 and M54. In the present embodiment, the energy storage circuit 540 simply includes a capacitor C5 and is coupled between the energy storage switch set 530 and the energy release switch set 535. The control unit 525 generates control signals S51-S54 corresponding to the transistor switches M51-M54 to perform the energy storage and the energy release of the energy storage circuit 540. The linear regulator 532 receives a detecting signal CS to limit the current charging the capacitor C5 to be lower than a current value to avoid the battery units Cell1 and Cell2 providing a huge current, which may affect or damage the battery unit, to charge the capacitor C5.

When the voltage of the battery unit Cell1 is smaller than that of the battery unit Cell2, during the first timing, the control unit 525 generates the control signal S51 to turn on the transistor switches M51 and cut off the other transistor switches, so that the capacitor C5 stores energy. Next, during the second timing, the control unit 525 generates the control signals S51 and S54 to turn on the transistor switches M51 and M54 and cut off the other transistor switches, so that the capacitor C5 releases the stored electric power to charge the battery unit Cell1 through the transistor switches M51 and M54. When the voltage of the battery unit Cell1 is larger than that of the battery unit Cell2, during the first timing, the control unit 525 generates the control signal S51 to turn on the transistor switches M51 and cut off the other transistor switches, so that the capacitor C5 stores energy. Next, during the second timing, the control unit 525 generates the control signals S52 and S53 to turn on the transistor switches M52 and M53 and cut off the other transistor switches, so that the capacitor C5 releases the stored electric power to charge the battery unit Cell2 through the transistor switches M52 and M53.

As the above description, the invention completely complies with the patentability requirements: novelty, non-obviousness, and utility. It will be apparent to those skilled in the art that various modifications and variations can be made to the structure of the invention without departing from the scope or spirit of the invention. In view of the foregoing descriptions, the invention covers modifications and variations thereof if they fall within the scope of the following claims and their equivalents.

What is claimed is:

1. A battery voltage balance apparatus, comprising:
a balance determining unit coupled to a plurality of battery units connected in series and determining whether to perform a battery voltage balance process according to battery voltages of each of the battery units; and
a converting unit having an energy storage circuit and coupled to the battery units, and in the battery voltage balance process, the converting unit storing energy to the energy storage circuit and selectively charging at least one of the battery units by the energy storage circuit, so that voltage differences between any two of the battery units are reduced to be lower than a first predetermined value or a first predetermined percentage.

2. The battery voltage balance apparatus as claimed in claim 1, wherein the converting unit has a switch module, and in the battery voltage balance process, the switch module couples the energy storage circuit to the battery unit having the highest battery voltage for storing the energy in the energy storage circuit, and the switch module couples the energy storage circuit to the battery units to charge the battery units.

3. The battery voltage balance apparatus as claimed in claim 1, wherein the converting unit has a switch module, and in the battery voltage balance process, the switch module couples the energy storage circuit to the battery units for storing the energy in the energy storage circuit, and the switch module couples the energy storage circuit to the battery unit having the lowest battery voltage to charge the battery unit having the lowest battery voltage.

4. The battery voltage balance apparatus as claimed in claim 1, wherein the converting unit has a switch module, and in the battery voltage balance process, the switch module couples the energy storage circuit to the battery unit having the highest battery voltage for storing the energy in the energy storage circuit, and the switch module couples the energy storage circuit to the battery unit having the lowest battery voltage to charge the battery unit having the lowest battery voltage.

5. The battery voltage balance apparatus as claimed in claim 1, wherein the converting unit comprises a boost converting circuit, and the boost converting circuit performs a boost operation according to the highest one of the battery voltages of the battery units, so that the energy storage circuit releases the energy to the battery units.

6. The battery voltage balance apparatus as claimed in claim 1, wherein the converting unit comprises a buck converting circuit, and the buck converting circuit performs a buck operation according to the battery voltages of the battery units, so that the energy storage circuit releases the energy to the battery unit having the lowest battery voltage.

7. The battery voltage balance apparatus as claimed in claim 6, wherein the buck converting circuit comprises a linear voltage regulator, the energy storage circuit comprises a capacitor, and the linear voltage regulator stores the energy in the capacitor, so that a voltage drop across the capacitor achieves a predetermined charge voltage.

8. The battery voltage balance apparatus as claimed in claim 1, wherein the energy storage circuit comprises an inductor, and in the battery voltage balance process, the converting unit controls a current flowing through the inductor to be lower than a limit current value.

9. The battery voltage balance apparatus as claimed in claim 1, wherein the energy storage circuit comprises an inductor, and in the battery voltage balance process, the converting unit controls a current flowing through the inductor substantially to a predetermined current value.

10. The battery voltage balance apparatus as claimed in claim 2, wherein the switch module comprises an energy storage switch set and an energy release switch set, the energy storage circuit stores the energy by the energy storage switch set, and the energy storage circuit releases the energy by the energy release switch set.

11. The battery voltage balance apparatus as claimed in claim 1, wherein after receiving a start signal, the balance determining unit starts to determine whether to perform the battery voltage balance process according to the battery voltages of each of the battery units.

12. The battery voltage balance apparatus as claimed in claim 1, wherein when determining that the voltage differences between any two of the battery units are higher than a second predetermined percentage or a second predetermined value, the balance determining unit performs the battery voltage balance process.

13. A battery charge apparatus, adapted to charge a battery module comprising a plurality of battery units connected in series, the battery charge apparatus comprising:
a charge control unit coupled to a power source and the battery module and controlling the power source to provide a charge current to the battery module to charge the battery module;
a balance determining unit coupled to the battery module and determining whether to perform a battery voltage balance process according to battery voltages of each of the battery units; and
a converting unit having an energy storage circuit and coupled to the battery units, and in the battery voltage balance process, the converting unit storing energy to the energy storage circuit and selectively charging at least one of the battery units by the energy storage circuit, so that voltage differences between any two of the battery units are reduced to be lower than a first predetermined value or a first predetermined percentage.

14. The battery charge apparatus as claimed in claim 13, wherein the converting unit comprises a buck converting circuit.

15. The battery charge apparatus as claimed in claim 13, wherein the converting unit comprises a boost converting circuit.

16. The battery charge apparatus as claimed in claim 15, wherein the buck converting circuit comprises a linear voltage regulator, the energy storage circuit comprises a capacitor, and the linear voltage regulator stores the energy in the capacitor, so that a voltage drop across the capacitor achieves a predetermined charge voltage.

17. The battery charge apparatus as claimed in claim 13, wherein the converting unit comprises an inductor.

18. The battery charge apparatus as claimed in claim 17, wherein the converting unit controls a current flowing through the inductor substantially to a predetermined current value or to be lower than a limit current value in the battery voltage balance process.

19. The battery charge apparatus as claimed in claim 13, wherein the charge control unit generates a start signal to start the balance determining unit to determine whether to perform the battery voltage balance process.

20. The battery charge apparatus as claimed in claim 13, wherein when determining that the voltage differences between any two of the battery units are higher than a second predetermined percentage or a second predetermined value, the balance determining unit performs the battery voltage balance process.
